(19) United States
(12) Patent Application Publication
(10) Pub. No.: US 2008/0158686 A1
(43) Pub. Date: Jul. 3, 2008

(54) Surface reflective portable eyewear display system and methods

(76) Inventor: Michael Chechelniker, Brooklyn, NY (US)

Correspondence Address: Michael Chechelniker, 3178 Nostrand ave. #5K, Brooklyn, NY, 11229, US

(21) Appl. No.: 11/618,830

(22) Filed: Dec. 31, 2006

(51) Int. Cl. G02B 27/01; G06K 9/36

(52) U.S. Cl. 359/631; 382/293

(57) ABSTRACT

Surface reflective portable eyewear display system and methods are disclosed. Invention comprises of vertical image inverting system that displays image in a mirror-flipped way on projection displays attached to the temples of a frame at an angle facing lenses of an eyewear. Said lenses of invention are half-silvered mirror coated, reflecting vertically inversed image in a mirror like way to the eyes of a wearer, making said reflected image a transparent virtual image over regular view through the glasses normally perceived. Invention incorporates a unique utility design that fits the shape of a head of a wearer and is pleasantly concealed.

### FIELD OF THE INVENTION

The invention relates to a portable display system that is embedded into eyewear utility such as glasses or goggles.

### BACKGROUND

It has been known that to make a portable eyewear imbedded display system, actual lcd or other type of display screen is placed in front of an eye. Military devices use single display, while many consumer devices use two such displays covering both eyes.

Invention is closely related to applications filed on behalf of The Microoptical Corporation and specifically titled “Eyeglass Interface System”, improving design and utility of above.

### SUMMARY OF THE INVENTION

The following invention improves portable eyewear display systems and their utility design.

Invention uses method of vertically inverting original image to be projected by display embedded in temples and reflecting said projected image off of the internal surface of lens of invention to be perceived naturally by wearer. Invention covers system and methods of such device, its design and of processing, making and calibrating one.

Invention comprises of an eyewear utility that is worn in a regular way. Projection displays are embedded into temples of such eyewear utility. Invention comprises of half-silvered mirror coated internal lens surface that reflects the image from temple attached projection displays of to the eyes of a wearer. Projected image is tweaked by internal or external image processor to fit the suitable reflected form that is perceived best by a wearer.

Invention uses inputted digital or analog image source of any type. Said source image is projected in the mirror flipped form from temple embedded displays that in turn is reflected as a normal image on the internal surface of the reflective lens of an eyewear. Said normal image is a virtual image that is perceived as a transparent image over normal view through glasses by the wearer.

In a two-way surface reflective portable eyewear display invention variation, a sensor reads eye position and size to adjust the best suitable image that fits the wearer's current intended state.

Invention allows users to view transparent display image while also viewing the surrounding environment by coordinating focus and attention. Eye sensors recognize size and direction of eye pupils modifying image accordingly. By using contrast of light emitted day and night time can be modulated for best perception by the wearer.

### DESCRIPTION OF THE DRAWINGS

FIG. 1 is perspective view of the invention.

FIG. 2 is perspective view of the invention and explanation of its main components and design functions.

FIG. 3 is a top view of the invention and its major component, display assembly.

FIG. 4 is a top view of display assembly being detached from the temple of a frame of an eyewear.

FIG. 5 is a top view of display assembly and explanation of its triangular shape with the three sides corresponding to utility of invention.

FIG. 6 is a perspective close up of display assembly showing projection display side, curved head shape fitting side, and a top of display assembly.

FIG. 7 represents methods of image manipulation and transformation throughout invention, wherein image is vertically inversed resembling a mirror reflection.

### DETAILED DESCRIPTION OF THE INVENTION

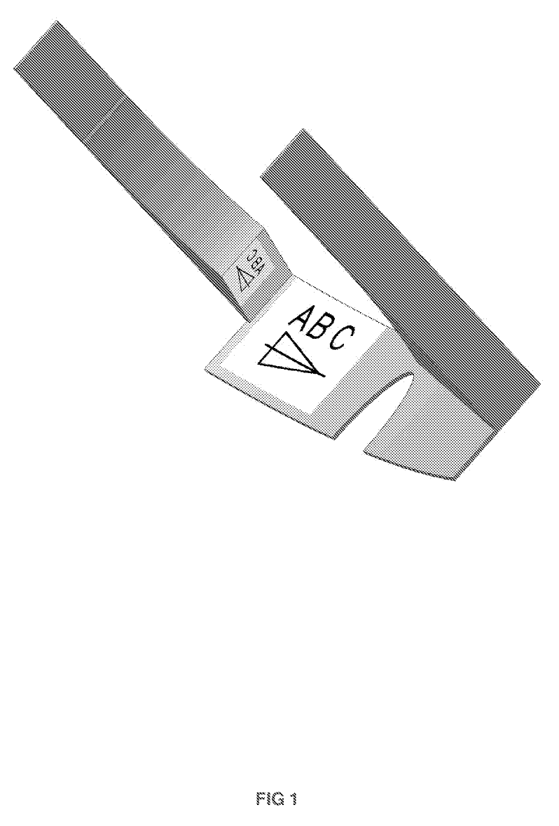

FIG. 1 shows perspective view of invention and its design.

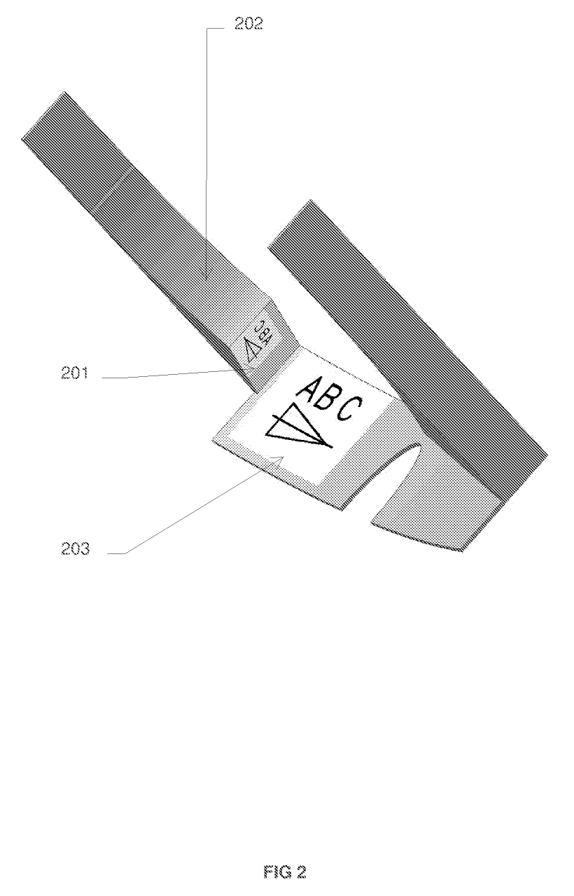

From FIG. 2 we can see left display assembly 202 is attached to the left temple of a frame of an eyewear utility. Image is being displayed by projection display in vertically inversed state 201, and optically reflected by reflecting lens 203. On reflective lens, virtual image is formed. Said virtual image is enlarged and shows letters “abc” and right pointing arrow 203. This image is a reflection of projection display image 201 that shows letters in reversed mirror like state, wherein letters are “cba” and arrow is left pointing.

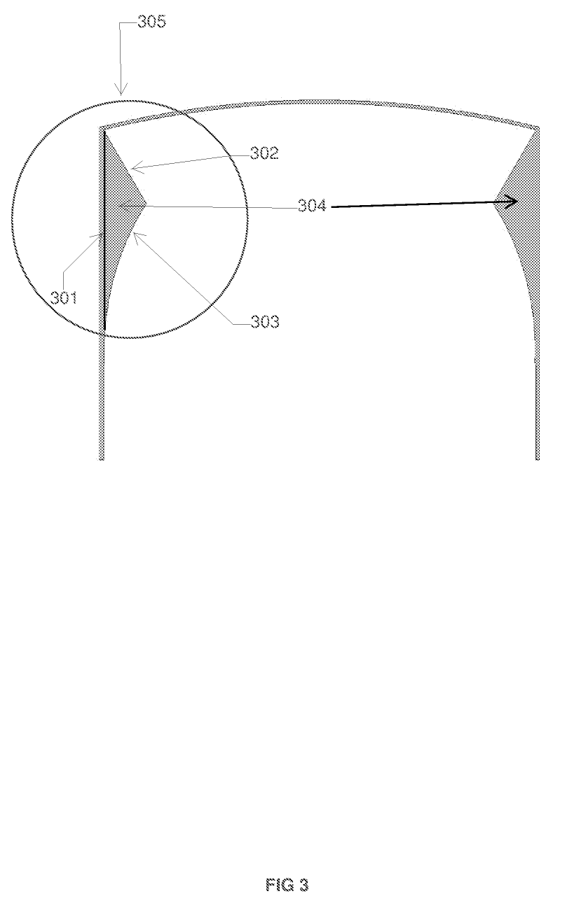

FIG. 3 represents view from the top of the invention. Display assembly 305, is attached to both sides of temples of eyewear 304, and resembles a triangle with one curved side. Left display assembly is detailed with descriptions, however is identical to the right display assembly with a difference in being mirror image of it. Left and right display assemblies are defined as such from the view of a top of an eyewear, as shown, or from a regular wear by a wearer. Shown display assembly comprises of three main sides that are major component of invention. First side is attached to the temple of a frame 301. Second side is the projection display side 302 that is facing reflective lens of a frame at an angle. Third side 303 is curved to fit the shape of a head of a wearer. This side of display assembly can be straight or curved for better fit.

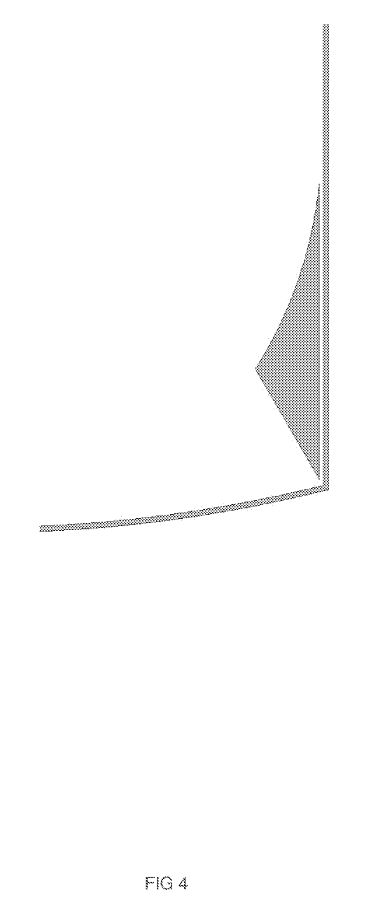

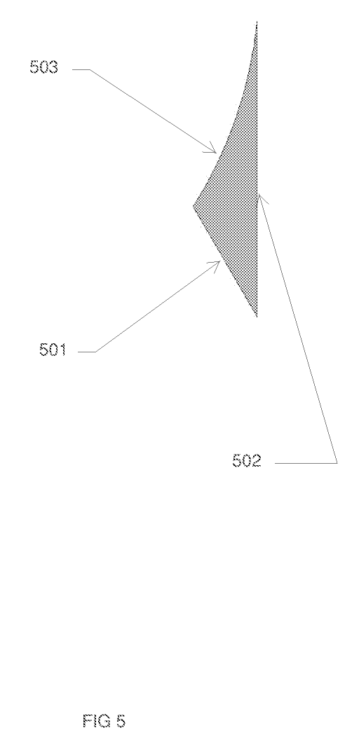

When detached from a frame FIG. 4, display assembly resembles triangle with one slightly curved side. This is one of major aspects of invention, along with relative positioning of the sides, and their function in utility. FIG. 5 details each side and their relative position and shape, wherein display side, temple attached side and curved fitting side are represented as 501, 502 and 503 accordingly.

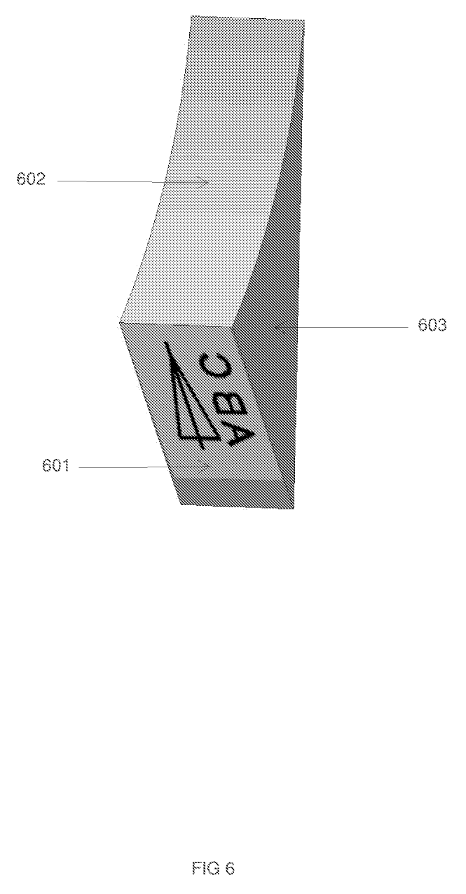

FIG. 6 represents enlarged perspective view of the display assembly. It is the same display assembly of presented invention that has been described in previous figures. Top side 603 is identical in shape to the figures of the top view of display assembly and is identical in shape and parallel to bottom of display assembly. Projection display side 601 and curved side 602 is shown enlarged and in perspective. The length of display assembly from top to bottom sides is such to incorporate a display 601. This is a projection display of invention. All three sides of display assembly are thus equal in length, taking perpendicular plane to top and bottom sides. Said length vector is parallel to vertical plane and perpendicular to horizontal plane of image being displayed 601 by projection display.

Invention uses any image source inputted via regular wired or wireless way. Video image processor is imbedded into invention in one aspect of invention, or outsourced in another. Digital or analog converters are in the same way embedded or outsourced. This is not the main aspect of invention.

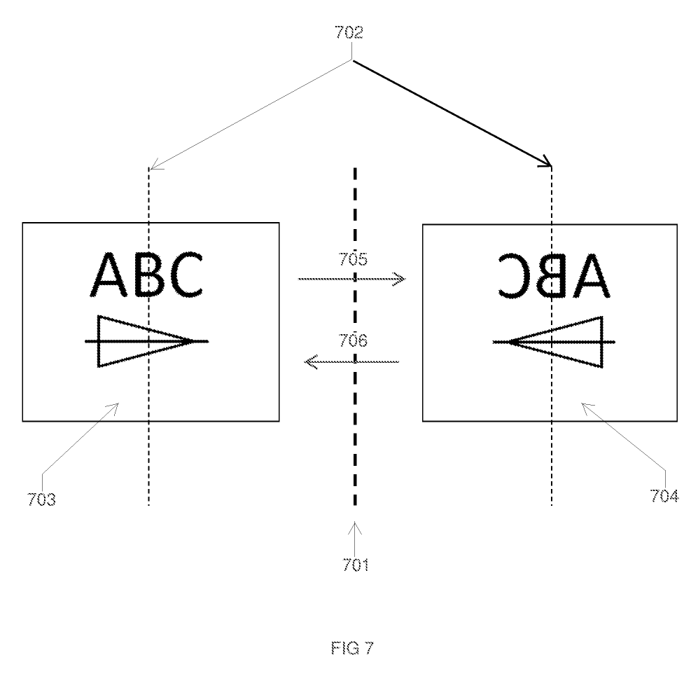

Invention comprises of vertical image inverting system that processes the image source inputted 703 to be a mirror reflection of itself 704 about vertical axis in the middle of horizontal plane 702, as shown in FIG. 7. This processing component is embedded into display assembly. Original source image is image of any source digital or analog that is inputted into invention and is shown as “abc” with right pointing arrow underneath, 703. Image inverting system uses image inverting electronic component of display assembly 705 to create vertically inverted image 704 that is display on projection display 601.

Said image that is displayed by projection display, is reflected by reflected lens of an eyewear to produce virtual image 703 that is similar to original source image naturally perceivable by a wearer, in a process of optical inversion 706. Projection display displayed image is being vertically inverted by optical inversion process, similar to mirror reflection, by reflecting lens that comprises of half-silvered mirror coating surface. The effect that is created, as perceived by a wearer, is transparent virtual image being displayed over regular view through the glass. The level of transparency of this virtual image is controlled by brightness, contrast ration, and other digitally regulated qualities of display of projection display.

Invention also comprises of method of calibrating the image to be synchronized with projective display system and optical reflective lens system for natural perception of a wearer. Said method uses image processing component of invention to control the pixilated image of display of projection display. Image is synchronized with optical inversion of reflecting lens and viewer perception to create the best naturally perceivable image by a wearer. Image in this process is tweaked with pixels being manipulated by computer processing to determine the best configuration.

In another aspect of invention eye sensor monitors position and the size of pupils of a wearer to determine what image is to be displayed on projection display.

Reflecting lenses of invention are concaved in one aspect of invention, allowing for image displayed to be magnified when perceived. Image synchronization process and method adjusts for this factor by the same principle of display image manipulation.

By coordinating the reflective surface production, in manufacturing of invention, with a projected image source, different systems are set up to enhance the projection of the image on such reflective surface. Focal and angular compatibility of reflective surface to adjust to temple displays is used in manufacturing of units of various designs, so that image from displays is reflected into normal perceptible picture to an eye. Different designs and variations of invention require different focal reflective length and reflective angular abilities.

Reflective sensors detect the image of an eye reflected by internal surface of reflecting lens. These sensors are located parallel or at an angle to an eye, mostly next to projection display at the temples of frame. Direct sensors detect pupil size from the eye itself, being located in front on the frame facing the eye.

Invention has the ability to be wired or wireless. In a wired aspect of invention, battery, external image processor, and other components can be outsourced. Wire is coming out of a temple of a frame at the rear end, behind the ear. Wire has ability to be connected with another processing unit, such as mini computer, that has wireless network, and software processing capability, or a simple video outputting device, such as portable video player, etc. Internal display assembly processor allows for image compatibility by modifying video stream in its own parameters that are recognized and displayed as a normal image to the eye.

The software of external processing unit allows invention to communicate with various navigational devices, such as wireless portable mini keyboards, etc. Invention can serve as a real time display for all portable needs in social and professional life. It can provide a real time GPS display for drivers; or a real time display for soldiers that receive a command, navigate a weapon, explore a terrain, etc. Invention can be used in social activity, such as receiving a private message, analyzing environment, etc. Invention can be mounted with video camera at the front of eyewear. This would help record or scan environment in further means.

The external surface of reflecting lenses is mirror reflective, or commonly called one way mirror or of similar quality so that image displayed to a user is not exposed to outsider. Beam splitter of half-silvered mirror coating surface is also used allow perpendicular to the lens rays of light through, thus allowing for normal view through the glasses, and blocking angled light rays coming from projection display, thus providing privacy of displayed image. Angled rays of light of projection display are reflected only, in this aspect of invention, and blocked from external view.

In another aspect of invention sync communication tool uses glass to external sensor mapping and displaying synchronization. External sensor maps an object and only displays a specific form on invention that fits a wearer perception in synchronization of real and projected image. Example: target square or circle underline. Using eye sensing sync, virtually mapped wearer perceived reality. Lead functions underlines broad view for wearer, then zooms in and leads the focus of an eye, (with double feed from user and leading ability), to a target. This two-way process senses pupil focal range, and displays a target of fit parameters. So that if focal range is close and intended target is far away, graphical target is displayed large to accommodate the wearer focal perception, but is positioned at a perfect center of intended target. As wearer begins to focus on intended target, graphical projected target image is shrinking in size making a perception to a wearer that it is “right on target”. Until target is reached or human focal range is at maximum. Then external optical zoom utility kicks in to project the image on invention of real zoomed target. This is done in contrast overlapping. Once image is projected from external source such as zoom beyond eye focal range, rather than from real life view, contrast of invention blinds the real image and only displays the zoomed level, as perceived by a wearer.

What is claimed is:

1. An eyewear display system comprising:
at least one display assembly triangular in shape with three sides, a top and a bottom, said shape with the first side of display assembly being a projection display that is facing towards lens of an eyewear at an angle, the second side of display assembly attached to a temple of an eyewear frame, and the third side of display assembly being straight or curved to fit the shape of a head of a wearer;
vertical image inverting system comprising image inverting electronic component processing analog or digital original source image to be displayed as vertically inverted image on the projection display resembling mirror reflection of original image, said displayed image in turn reflected via optical reflecting lens of an eyewear to be perceived naturally by a wearer as originally intended and identical to original source image;
projection display whose horizontal axis of image displayed is parallel to frame axis comprising lcd, oled, or other type of display;
concave half-silvered mirror coated optical reflecting lens of an eyewear, reflecting image from projection display to be perceived naturally by a wearer, allowing said wearer to also view naturally trough the glass of the lens and to view the reflective image as transparent virtual image of original image source.

2. An eyewear display system of claim 1, wherein there is at least one display assembly attached to temples of the frame of an eyewear.

3. An eyewear display system of claim 1, wherein display assembly comprises triangular shape extruded along the temple height.

4. An eyewear display system of claim 1, wherein display assembly comprises three sides, a top and a bottom.

5. An eyewear display system of claim 1, wherein the first side of display assembly is projection display facing reflective lens of an eyewear.

6. An eyewear display system of claim 1, wherein the second side of display assembly is attached to the temple of an eyewear frame.

7. An eyewear display system of claim 1, wherein the third side of display assembly is curved to fit the shape of a head of a wearer.

8. An eyewear display system of claim 1, wherein vertical image inverting system comprising image inverting electronic component located inside the display assembly.

9. An eyewear display system of claim 1, wherein vertical image inverting system comprising image inverting electronic component located outside of the display assembly.

10. An eyewear display system of claim 1, wherein vertical image inverting system comprising original source image that is received by image inverting electronic component.

11. An eyewear display system of claim 1, wherein vertical image inverting system comprising vertically inverted image that is outputted by image inverting electronic component.

12. Vertical image inverting system of claim 11, wherein vertically inverted image is a mirror inverted copy of original source image.

13. Vertical image inverting system of claim 11, wherein vertically inverted image is displayed by projection display.

14. An eyewear display system of claim 1, wherein projection display is a digital display.

15. An eyewear display system of claim 1, wherein projection display displays images whose horizontal axis are parallel to axis crossing temples and lenses of a frame.

16. An eyewear display system of claim 1, wherein reflecting lens is coated with half-silvered mirror coating that is part reflective and transparent.

17. An eyewear display system of claim 1, wherein reflecting lens comprises optically reflected image by a mirror coating.

18. Reflecting lens of claim 17, wherein optically reflected image is a virtual image of original source image, naturally perceived by a wearer.

19. An eyewear display system of claim 1, wherein a virtual image of original source image is optically reflected image of vertically inverted image.

20. An eyewear display system of claim 1, wherein a virtual image of original source image is naturally perceived by a wearer as a transparent image over natural view through the glass.

21. Method of mirror like inversion of original source image by vertical image inverting system to produce vertically inverse image comprises:
horizontal plane of a processing image;
vertical middle axis on horizontal plane of processing image located at exact middle of horizontal plane;
horizontal plane of original source image;
horizontal plane of vertically inverse image being reflection of each horizontal point of original source image over middle vertical axis;
coordinate system comprising of vertical middle axis being vertical coordinate axis in the middle of horizontal coordinate plane.

22. Method of claim 21, wherein processing image is image being processed by image inverting electric component.

23. Method of claim 21, wherein vertical middle axis is axis positioned at exact middle of horizontal plane of processing image.

24. Method of claim 21, wherein vertical middle axis of horizontal plane of original source image is identical to vertical middle axis of horizontal plane of vertically inverted image by being positioned in the middle.

25. Method of claim 21, wherein each horizontal point of vertically inverse image is negative reflection over vertical middle axis of same horizontal point of original image source.

26. Method of claim 21, wherein each horizontal point of vertically inverse image is negative in sign corresponding to same horizontal point of original source image over vertical middle axis.

27. Method of claim 21, wherein coordinate system is the same for original source image, processing image, and vertically inverse image with vertical middle axis being in the center of horizontal coordinate plane.

28. Method of calibrating the image to be synchronized with projective display system and optical reflective lens system for natural perception of a wearer comprising synchronization processing component that is similar in function to vertical image inverting system, comprising of processing and tweaking of vertically inverted image to be calibrated with reflective lens to create a naturally perceptive virtual image of original source image.

29. Method of calibrating the image of claim 28, wherein synchronization processing component is located within display assembly.

30. Method of calibrating the image of claim 28, wherein synchronization processing component is located outside display assembly.

31. Method of calibrating the image of claim 28, wherein synchronization processing component is tweaked to output the best possible image naturally perceived by a wearer.

32. Method of calibrating the image of claim 28, wherein synchronization processing component is outputting image to projection display.
